(19) United States
(12) Patent Application Publication
(10) Pub. No.: US 2025/0096634 A1
(43) Pub. Date: Mar. 20, 2025

(54) INSULATOR STRUCTURE

(71) Applicants: HONDA MOTOR CO., LTD., Tokyo (JP); Matsuo Industries, Inc., Obu-shi (JP)

(72) Inventors: Shuhei Tanaka, Wako-shi (JP); Atsushi Kubota, Wako-shi (JP); Ryuzo Sakamoto, Wako-shi (JP); Shogo Takano, Wako-shi (JP); Keiya Nimura, Wako-shi (JP); Shigetoshi Yamashita, Obu-shi (JP); Hiromu Nakai, Obu-shi (JP)

(21) Appl. No.: 18/814,863

(22) Filed: Aug. 26, 2024

(30) Foreign Application Priority Data
Sep. 20, 2023 (JP) 2023-152728

(51) Int. Cl. H02K 3/52

(52) U.S. Cl. CPC H02K 3/527; H02K 2203/12

(57) ABSTRACT

An insulator includes: an outer circumferential piece; an inner circumferential piece that faces the outer circumferential piece in a teeth portion axis direction; and a winding portion that connects the outer circumferential piece to the inner circumferential piece, wherein a space surrounded by the outer circumferential piece, the inner circumferential piece, and the winding portion is a storage portion of a winding wire, a protrusion portion and an inner circumferential side recess portion are provided on one side in a motor axis direction of the inner circumferential piece, a protrusion portion inclination surface that is inclined so as to be located at an outer position in a motor radial direction toward another side in a motor circumferential direction when seen from the motor axis direction is provided on an inner end section in the motor radial direction of the protrusion portion, and an inclination groove portion that is inclined along an extension section of the protrusion portion inclination surface when seen from the motor axis direction is provided on a first side in the motor axis direction of the insulator.

### CROSS-REFERENCE TO RELATED APPLICATION

Priority is claimed on Japanese Patent Application No. 2023-152728, filed on Sep. 20, 2023, the contents of which are incorporated herein by reference.

### BACKGROUND

### Field of the Invention

The present invention relates to an insulator structure.

### Background

In recent years, efforts intended to realize a low carbon society or a decarbonized society have been made, and in order to reduce CO2 emissions and improve the energy efficiency even in vehicles, research and development relating to electrification techniques has been conducted.

For example, in a dynamoelectric machine such as a vehicle drive motor, a winding wire field type may be employed although the mainstream is an embedded magnet type. In the winding wire field type motor, a coil is arranged on a rotor in place of a permanent magnet, and by causing a current to flow through the coil, a magnetic flux is generated at the rotor. In the winding wire field type motor, by enabling adjustment of a magnetic flux amount of the rotor, a highly efficient operation is expected, and by using no permanent magnet, there is also no concern on the stable supply of rare earth.

That is, at least one of a stator and the rotor of the motor includes an annular portion having an annular shape, a plurality of cores (teeth portions) that radially protrude to an inner side or an outer side in a radial direction of the annular portion; and a coil in which a conductor wire is wound around an outer circumference of each core.

For example, Japanese Unexamined Patent Application, First Publication No. 2006-187073 discloses a configuration in which a guide groove that accommodates a winding starting portion of a winding wire such that the winding starting portion is guided from an outer side in a motor radial direction to an inner side is provided on a winding portion that winds the winding wire in an insulator.

### SUMMARY

In the related art described above, since the guide groove is provided, the thickness of the winding portion is increased, the physical size of a coil end is increased, and there is a possibility that the alignment property of an upper layer and a subsequent layer is deteriorated.

An aspect of the present invention aims to provide an insulator structure capable of reducing the physical size of a coil end and ensure the alignment property of an upper layer and a subsequent layer. Further, the aspect of the present invention contributes to the improvement of energy efficiency.

An insulator structure according to a first aspect of the present invention is a structure of an insulator mounted on each of a plurality of teeth portions aligned in a motor circumferential direction, including: an outer circumferential piece that is provided on one end side in a teeth portion axis direction along a motor radial direction in a teeth portion among the plurality of teeth portions; an inner circumferential piece that is provided on another end side in the teeth portion axis direction in the teeth portion and faces the outer circumferential piece in the teeth portion axis direction; and a winding portion which covers an outer circumference of the teeth portion when seen from the teeth portion axis direction, connects the outer circumferential piece to the inner circumferential piece, and around which a winding wire is wound, wherein a space surrounded by a first facing surface of the outer circumferential piece that faces an inner circumferential piece side, a second facing surface of the inner circumferential piece that faces an outer circumferential piece side, and an outer surface of the winding portion is a storage portion of the winding wire, a protrusion portion that is arranged on one side in the motor circumferential direction and protrudes to one side in a motor axis direction further than the winding portion and an inner circumferential side recess portion which is arranged to avoid the protrusion portion in the motor circumferential direction, which is recessed in the motor axis direction relative to the protrusion portion, and through which the winding wire is capable of being inserted across an outer side and an inner side in the motor radial direction of the inner circumferential piece are provided on a first side in the motor axis direction of the inner circumferential piece, a protrusion portion inclination surface that is inclined so as to be located at an outer position in the motor radial direction from one side toward another side in the motor circumferential direction when seen from the motor axis direction and causes an extension section to another side in the motor circumferential direction to intersect the inner circumferential side recess portion is provided on an inner end section in the motor radial direction of the protrusion portion, and an inclination groove portion that is inclined along the extension section of the protrusion portion inclination surface when seen from the motor axis direction and enables insertion of the winding wire is provided on a first side in the motor axis direction of the insulator.

According to this configuration, the protrusion portion as a tangle portion or the like of the winding wire is formed on a first side in the motor axis direction in the inner circumferential piece of the insulator, the inner circumferential side recess portion is formed at a position that avoids the protrusion portion, the protrusion portion inclination surface that is inclined to the outer side (winding portion side) in the motor radial direction is formed on the outer end section in the motor radial direction of the protrusion portion, and the inner circumferential side recess portion through which the winding wire passes and the inclination groove portion in which the winding wire is inserted are formed in the extension direction of the protrusion portion inclination surface. When introducing the winding wire toward the winding portion from an access region on a further inner side in the motor radial direction than the inner circumferential piece, by introducing the winding wire along the protrusion portion inclination surface to the winding portion side, the winding wire linearly extends, passes through the inner circumferential side recess portion, and is inserted into the inclination groove portion. In this way, by storing a winding starting portion of the winding wire in the inclination groove portion and guiding the winding wire toward the winding portion from the inner circumferential piece side (the inner side in the motor radial direction), it is possible to improve the workability of the winding wire. Further, by providing an inclination toward the outer side from the inner side in the motor radial direction, it is possible to improve the adhesiveness to the winding portion of the winding wire, prevent the winding wire from flying out into a slot, ensure the alignment property of an upper layer and a subsequent layer, and reduce the physical size of a coil end.

A second aspect of the present invention is the insulator structure according to the first aspect described above, wherein in a cross section that intersects the motor radial direction, a chamfering shape may be formed on the winding portion at a corner section between an axis direction end surface on a first side in the motor axis direction and a circumferential direction end surface on another side in the motor circumferential direction, and in the cross section that intersects the motor radial direction, a second inclination groove portion that is inclined along the chamfering shape, continues in an extension direction to another side in the motor circumferential direction of the inclination groove portion when seen from the motor axis direction, and enables insertion of the winding wire may be provided on the first side in the motor axis direction of the insulator.

According to this configuration, by enabling insertion of the winding wire into the second inclination groove portion that communicates with the extension direction of the inclination groove portion and inclining the second inclination groove portion along the chamfering shape of the winding portion in a cross-sectional view, when introducing the winding wire toward the winding portion from the access region on the further inner side in the motor radial direction than the inner circumferential piece, the winding wire smoothly merges to a corner section in the cross-sectional view of the winding portion. Thereby, by preventing bending or curving at the winding starting portion of the winding wire and improving the adhesiveness between the winding wire and the insulator, it is possible to prevent the winding wire from flying out into the slot, ensure the alignment property of the upper layer and the subsequent layer, and reduce the physical size of the coil end.

A third aspect of the present invention is the insulator structure according to the second aspect described above, wherein a pair of protrusion portions, a pair of inclination groove portions, and a pair of second inclination groove portions may be provided to be symmetric using a center axis line of the teeth portion as a symmetry axis when seen from the motor axis direction.

According to this configuration, by providing the pair of protrusion portions, the pair of inclination groove portions, and the pair of second inclination groove portions so as to be symmetric in the motor circumferential direction, regardless of a direction of the winding starting portion of the winding wire with respect to the winding portion being a CCW (counterclockwise) or a CW (clockwise), it is possible to prevent the winding wire from flying out into the slot, ensure the alignment property of the upper layer and the subsequent layer, and reduce the physical size of the coil end.

According to the aspect of the present invention, it is possible to provide an insulator structure capable of preventing a winding route from entering the slot, ensuring the alignment property of the upper layer and the subsequent layer, and reducing the physical size of the coil end.

### BRIEF DESCRIPTION OF THE DRAWINGS

FIG. 1 is an exploded perspective view of a motor in an embodiment of the present invention.

FIG. 2 is a plan view of a portion in a circumferential direction of a rotor of the motor when seen from an axis direction and includes a partial cross section.

FIG. 3 is a perspective view of an insulator mounted on a teeth portion of the rotor.

FIG. 4 is a plan view around an inner circumferential piece of the insulator when seen from a motor axis direction.

FIG. 5 is a V-V cross-sectional view of FIG. 4.

### DESCRIPTION OF EMBODIMENTS

Hereinafter, an embodiment of the present invention will be described with reference to the drawings.

### Motor 1

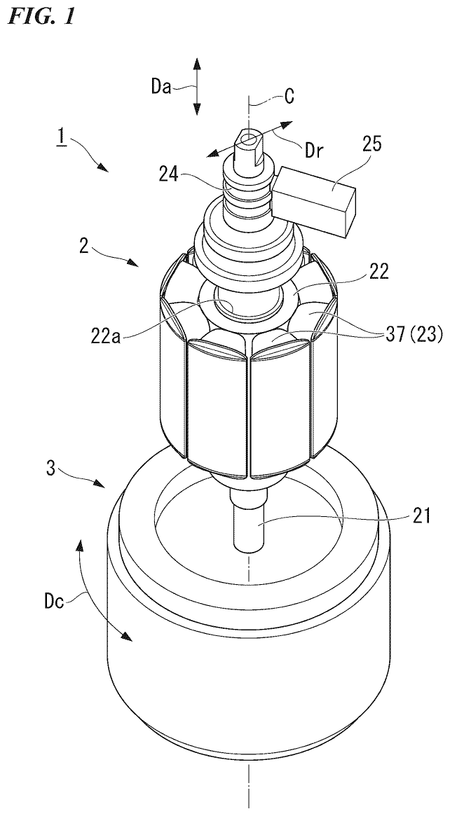

FIG. 1 is an exploded perspective view of a motor (dynamoelectric machine) 1 to which an embodiment of the present invention is applied.

As shown in FIG. 1, the motor 1 includes a rotor 2, a stator 3, and a casing (not shown) that covers the rotor 2 and the stator 3. In the present embodiment, the rotor 2 is arranged on an inner circumferential side relative to the stator 3. That is, the motor 1 is an inner rotor type motor.

The motor 1 of the embodiment is a drive motor for electric vehicles. Further, the motor 1 of the embodiment is a winding wire field type motor and has a rotor structure using a field winding wire (coil 37) instead of a permanent magnet. By causing a direct current to flow through the field winding wire from the outside, the motor 1 generates a magnetic flux at the rotor 2 and enables adjustment of the field magnetic flux.

### Rotor 2

The rotor 2 includes a rotation shaft 21, a rotor core 22, a plurality of magnetic pole portions 23, and a commutator 24.

The rotation shaft 21 extends in an axis direction (motor axis direction) Da. The rotation shaft 21 is supported by a casing (not shown) via a bearing (not shown). The rotation shaft 21 is supported rotatably in a circumferential direction (motor circumferential direction) Dc around an axis line C extending in an axis direction Da.

The rotor core 22 is provided on an outer side (outer circumferential side) in a radial direction (motor radial direction) Dr around the axis line C relative to the rotation shaft 21. The rotor core 22 is formed in a cylindrical shape such that the axis line C is an axis center. When seen from the axis direction Da, a shaft insertion hole 22a through which the rotation shaft 21 is inserted is formed on a center portion of the rotor core 22. The rotor core 22 is rotatable in the circumferential direction De integrally with the rotation shaft 21.

The plurality of magnetic pole portions 23 are arranged at equal intervals to be spaced apart from each other in the circumferential direction Dc on an outer circumference portion of the rotor core 22. Each magnetic pole portion 23 includes the coil 37. The coil 37 is formed by winding a winding wire 32 via an insulator 38 on an outer circumference of a teeth portion 35 formed on the rotor core 22. Details of the coil 37 and the insulator 38 will be described later.

The commutator 24 is coaxially provided on one end portion of the rotation shaft 21. The commutator 24 is rotatable in the circumferential direction Dc integrally with the rotation shaft 21. A brush 25 that is supported by the casing faces and is in contact with the commutator 24 in a radial direction Dr.

### Stator 3

The stator 3 is arranged with a gap (air gap) on an outer circumferential side in the radial direction Dr relative to the rotor core 22. The stator 3 is fixed on an inner circumferential side in the radial direction Dr of the casing. The stator 3 includes a stator core (not shown) and a plurality of magnetic pole portions (not shown).

### Details of Rotor 2

Hereinafter, the rotor 2 is described in more detail.

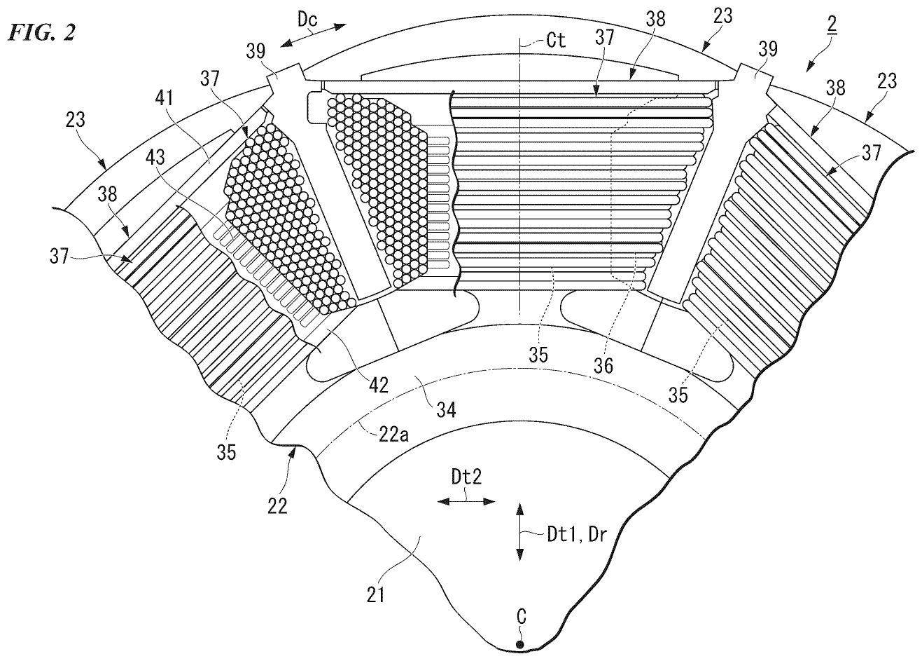

As shown in FIG. 2, the rotor core 22 integrally includes an annular portion 34 and a plurality of teeth portions 35.

The annular portion 34 is formed on an inner circumferential side (rotation shaft 21 side) of the rotor core 22. The annular portion 34 extends in the circumferential direction Dc and is formed in an annular shape when seen from the axis direction Da.

The plurality of teeth portions 35 are formed at equal intervals to be spaced apart from each other in the circumferential direction Dc. Each teeth portion 35 extends from an outer circumference section of the annular portion 34 along the radial direction Dr to an outer circumferential side. A slot 36 is formed between the teeth portions 35 adjacent to each other in the circumferential direction Dc. The slot 36 is in a form in which the outer circumferential side of the rotor core 22 is cut out.

The number of the formed slot 36 and the formed teeth portion 35 is the same (eight in the embodiment) as each other. The rotor core 22 may have a configuration that can be divided in the circumferential direction Dc for each of the plurality of teeth portions 35. A line Ct in FIG. 2 represents a center axis line along a center axis line (a protrusion direction (motor radial direction Dr) of the teeth portion 35) of the teeth portion 35. Hereinafter, a protrusion direction of the teeth portion 35 is referred to as a teeth portion axis direction Dt1, and a direction orthogonal to the teeth portion axis direction Dt1 is referred to as a teeth portion radial direction Dt2.

The winding wire 32 is a conductor wire (for example, a copper wire) and is held by the rotor core 22 in a form of the coil 37. The winding wire 32 is wound around each of the plurality of teeth portions 35 via an insulator 38 made of an insulating resin. The winding wire 32 is wound such that a plurality of layers are laminated on an outer circumference of the teeth portion 35 when seen from the teeth portion axis direction Dt1. The winding wire 32 is wound around each teeth portion 35, and thereby, a plurality of coils 37 that are aligned to be spaced apart from each other in the circumferential direction Dc are formed on the rotor 2. A slot pole (insulation plate) 39 made of an insulating resin is inserted between the pair of coils 37 that are adjacent to each other in the circumferential direction Dc.

### Insulator 38

As shown in FIG. 2, the insulator 38 of the embodiment includes: an outer circumferential piece 41 that has a flange shape and is provided on one end side (motor outer circumferential side) in the teeth portion axis direction Dt1; an inner circumferential piece 42 that has a flange shape and is provided on another end side (motor inner circumferential side) in the teeth portion axis direction Dt1; and a side wall portion (winding portion) 43 that has a cylindrical shape and connects the outer circumferential piece 41 and the inner circumferential piece 42 to each other. An inner space surrounded from three sides by facing surfaces 41a, 42a (a first facing surface 41a, a second facing surface 42a) of the outer circumferential piece 41 and the inner circumferential piece 42 and an outer surface 43a of the winding portion 43 is a storage portion 45 that stores the coil 37 in which the winding wires 32 are laminated. The slot 36 is formed of a pair of storage portions 45 that are adjacent to each other in the motor circumferential direction Dc. The winding wires 32 are densely arranged by being stacked in a so-called bale form in the storage portion 45.

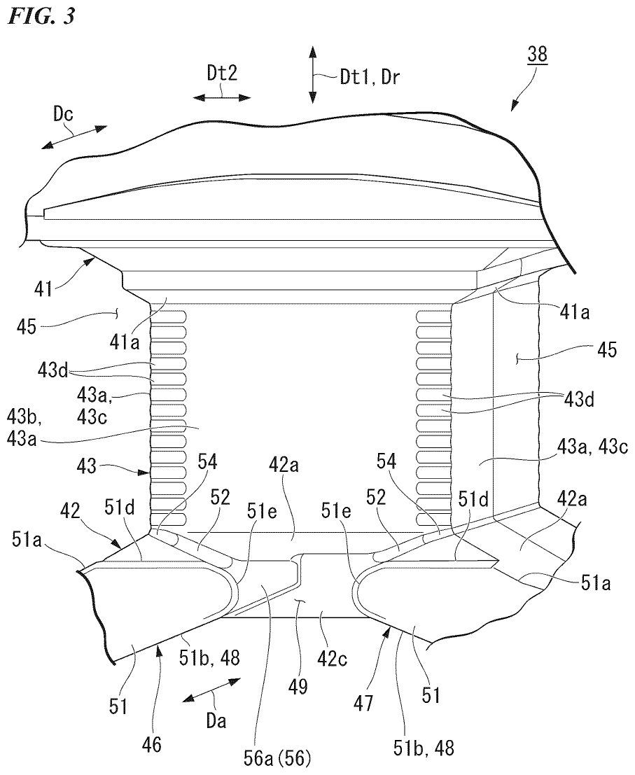

As shown in FIG. 3 to FIG. 5, a chamfering shape 43d is formed on the winding portion 43 at each of corner sections between an axis direction end surface 43b on a first side in the motor axis direction Da and circumferential direction end surfaces 43c on both sides in the motor circumferential direction Dc. The chamfering shape 43d is, for example, a round chamfering shape but may be a flat chamfering shape. A similar chamfering shape may be also formed on a second side in the motor axis direction Da of the winding portion 43.

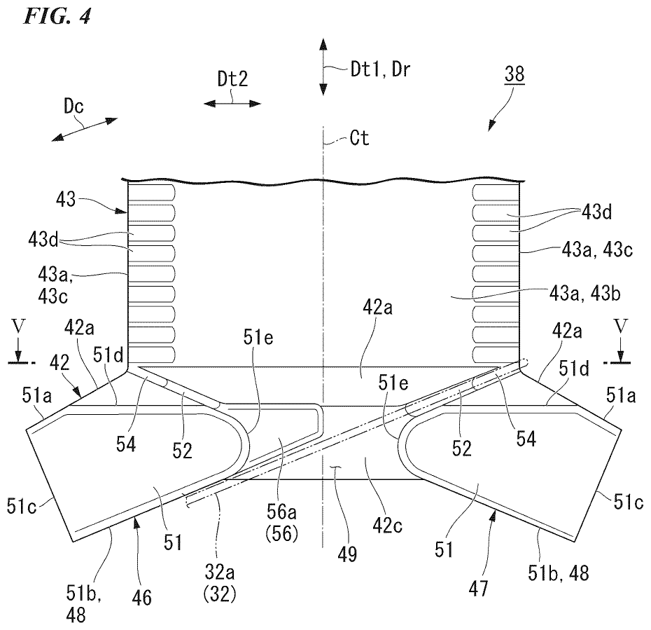

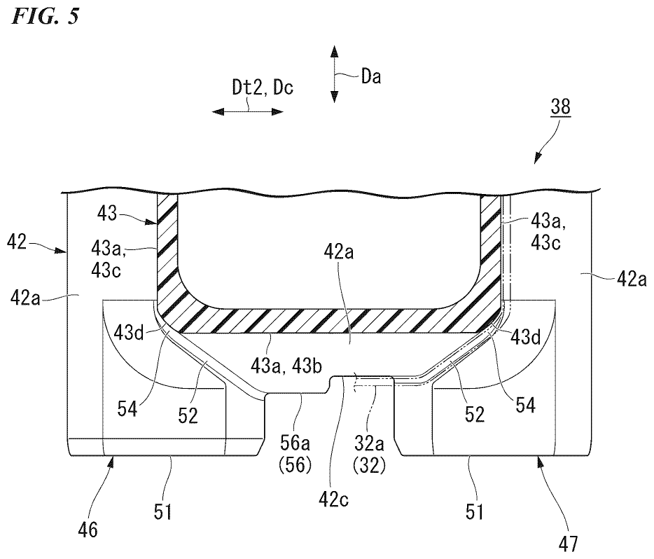

The cross section shown in FIG. 5 shows a cross section (V-V cross section in FIG. 4) orthogonal to the center axis line Ct in the insulator 38. Hereinafter, the cross section of FIG. 5 is referred to as an “axis orthogonal cross section”.

A pair of protrusion portions 46, 47 that are aligned in the motor circumferential direction Dc and an inner circumferential side recess portion 49 that is located between the pair of protrusion portions 46, 47 are provided on a first side in the motor axis direction Da of the inner circumferential piece 42. The pair of protrusion portions 46, 47 and the inner circumferential side recess portion 49 are provided only on the first side in the motor axis direction Da and may not be provided on a second side in the motor axis direction Da.

The pair of protrusion portions 46, 47 are arranged on both outer sides in the motor circumferential direction Dc. Each protrusion portion 46, 47 protrudes to a first side in the motor axis direction Da further than an end surface (base end surface 42c) of the inner circumferential piece 42 on the first side in the motor axis direction Da. The facing surface 42a of the inner circumferential piece 42 is an inclination surface inclined such that a further outer side (a side away from the center axis line Ct) from the inner side (a center axis line Ct side) in the teeth portion radial direction Dt2 is located at an inner side (a motor inner circumferential side) in the motor radial direction Dr.

A protrusion front end surface 51 to a first side in the motor axis direction Da of each protrusion portion 46, 47 is formed substantially in parallel with the axis direction end surface 43b (a plane orthogonal to the motor axis direction Da) of the winding portion 43.

With reference to FIG. 4, the protrusion front end surface 51 includes: an outer side 51a and an inner side 51b that extend to be inclined along the motor circumferential direction Dc with respect to the teeth portion radial direction Dt2 when seen from the motor axis direction Da; a circumferential direction end side 51c that connects between outer end portions in the motor circumferential direction Dc of the outer side 51a and the inner side 51b and extends along the motor radial direction Dr; a second outer side 51d that extends along the teeth portion radial direction Dt2 from an inner end portion in the motor circumferential direction Dc of the outer side 51a; and an arc side 51e that protrudes inward in the motor circumferential direction Dc and extends between an inner end portion in the motor circumferential direction Dc of the second outer side 51d and an inner end portion in the motor circumferential direction Dc of the inner side 51b.

The inner circumferential side recess portion 49 is formed between the arc sides 51e in the pair of protrusion portions 46, 47. The inner circumferential side recess portion 49 is formed so as to avoid each protrusion portion 46, 47 in the motor circumferential direction Dc. An end surface on a first side in the motor axis direction Da of the inner circumferential side recess portion 49 corresponds to an end surface (base end surface 42c) on a first side in the motor axis direction Da of the inner circumferential piece 42 excluding each protrusion portion 46, 47.

The inner circumferential side recess portion 49 is provided so as to be recessed to a second side in the motor axis direction Da with respect to each protrusion portion 46, 47. The inner circumferential side recess portion 49 enables arrangement of the winding wire 32 in a region between the protrusion front end surface 51 of each protrusion portion 46, 47 and the base end surface 42c of the inner circumferential side recess portion 49 in the motor axis direction Da.

The inner circumferential side recess portion 49 enables insertion of a conductor wire (winding wire 32) across an inner region (a region in which the conductor wire (crossing wire) extending between the coils 37 that are adjacent to each other is arranged) in the motor radial direction Dr of the inner circumferential piece 42 and an outer region (a region on the winding portion 43 side) in the motor radial direction Dr of the inner circumferential piece 42.

A protrusion portion inclination surface 48 that is inclined so as to be located at an outer position in the motor radial direction Dr from one side (a side where each protrusion portion 46, 47 itself is provided) toward another side in the motor circumferential direction Dc when seen from the motor axis direction Da is formed on an inner end section (a section along the inner side 51b) in the motor radial direction Dr of each protrusion portion 46, 47. The protrusion portion inclination surface 48 causes an extension section to another side in the motor circumferential direction Dc to intersect the inner circumferential side recess portion 49 when seen from the motor axis direction Da.

Thereby, when introducing a winding starting portion 32a (refer to FIG. 4) of the winding wire 32 from the inner side (a crossing wire side) in the motor radial direction Dr to the outer side (a winding portion 43 side) in the motor radial direction Dr, if the conductor wire tangled with one of the protrusion portions is pulled out along the protrusion portion inclination surface 48 to another side in the motor circumferential direction Dc, the conductor wire (winding wire 32) naturally passes through the inner circumferential side recess portion 49 and reaches the outer side in the motor radial direction Dr of the inner circumferential piece 42.

An inclination groove portion 52 that is inclined along the extension section of the protrusion portion inclination surface 48 when seen from the motor axis direction Da is formed on the facing surface 42a of the inner circumferential piece 42 in a first side in the motor axis direction Da of the insulator 38.

With reference to FIG. 4, the inclination groove portion 52 allows the winding wire 32 that extends from one (the left protrusion portion 46 in an example of FIG. 4) of the protrusion portions 46, 47 and passes through the inner circumferential side recess portion 49 to drop into the groove while extending linearly when seen from the motor axis direction Da. The inclination groove portion 52 in combination with the protrusion portion inclination surface 48 favorably guides the winding wire 32 in a prescribed arrangement route and prevents the winding wire 32 that intersects the facing surface 42a from flying out onto the facing surface 42a.

As shown in FIG. 3 to FIG. 5, the chamfering shape 43d is formed on each of corner sections on both sides in the motor circumferential direction Dc of the winding portion 43 in a first side in the motor axis direction Da of the insulator 38.

A second inclination groove portion 54 is formed so as to continue to the extension direction to the outer side in the motor circumferential direction Dc of the inclination groove portion 52 when seen from the motor axis direction Da on a first side in the motor axis direction Da of the insulator 38. The second inclination groove portion 54 continues to the inclination groove portion 52 in a straight line form when seen from the motor axis direction Da.

For example, when the chamfering shape 43d of the winding portion 43 is a round chamfering shape, the second inclination groove portion 54 is formed along a tangent line of the chamfering shape 43d of the winding portion 43 in an axis orthogonal cross section shown in FIG. 5. When the chamfering shape 43d of the winding portion 43 is a flat chamfering shape, the second inclination groove portion 54 may be formed along the chamfering shape 43d of the winding portion 43 in the axis orthogonal cross section. Thereby, when the winding wire 32 is introduced from an access region toward the winding portion 43, since the winding wire 32 smoothly merges to the corner section of the winding portion 43 and is wound, bending or curving at the winding starting portion 32a of the winding wire 32 is prevented.

The chamfering shape 43d forms a groove shape along the outer diameter of each of the winding wires 32 wound around the winding portion 43, and a plurality of chamfering shapes 43d are aligned in the teeth portion axis direction Dt1 and are formed in a wave shape. Thereby, the position in the teeth portion axis direction Dt1 of each of the winding wires 32 is easily determined, and the alignment property of the winding wire 32 is ensured.

With reference to FIG. 4, a pair of protrusion portions 46, 47, a pair of inclination groove portions 52, and a pair of second inclination groove portions 54 are provided to be symmetric using the center axis line Ct of the teeth portion 35 as a symmetry axis when seen from the motor axis direction Da. Thereby, even when a direction of the winding starting portion 32a of the winding wire 32 with respect to the winding portion 43 is a CCW (counterclockwise) direction as shown in FIG. 4 or is an opposite (CW (clockwise)) direction thereof, the winding wire 32 is favorably guided to the prescribed arrangement route, and the winding starting portion 32a of the winding wire 32 is prevented from flying out on the arrangement route.

In the embodiment, a displacement portion 56 having a lower protrusion height in the motor axis direction Da than each protrusion portion 46, 47 is formed on an end surface (the base end surface 42c of the inner circumferential piece 42) on a first side in the motor axis direction Da of the inner circumferential side recess portion 49 in a first side in the motor axis direction Da of the insulator 38. The displacement portion 56 has an outer shape in which when seen from the motor axis direction Da, the second outer side 51d and the inner side 51b of the protrusion portion 46 (the protrusion portion 46 on a side where the winding starting portion 32a of the winding wire 32 is in contact with the protrusion portion inclination surface 48) on one side in the motor circumferential direction Dc extend to the vicinity of the center axis line Ct. A step having a height similar to the diameter of the conductor wire is formed on an outer shape section when the displacement portion 56 is seen from the motor axis direction Da.

The winding starting portion 32a of the winding wire 32 extends along the inner side 51b so as to avoid the displacement portion 56, passes through the inclination groove portion 52 and the second inclination groove portion 54 on the protrusion portion 47 side on another side in the motor circumferential direction Dc, and is wound around the winding portion 43. A winding ending portion (not shown) of the winding wire 32 passes through the second inclination groove portion 54 and the inclination groove portion 52 on the protrusion portion 46 side on one side in the motor circumferential direction Dc, is pulled out to the outside of the coil 37, and intersects the winding starting portion 32a when passing through the inner circumferential side recess portion 49. At this time, the winding ending portion extends on a displacement surface 56a of the displacement portion 56 and therefore does not ride on the winding starting portion 32a on the base end surface 42c, and an intersecting section of the winding ending portion and the winding starting portion 32a is prevented from protruding in the motor axis direction Da.

As described above, the insulator structure in the embodiment described above is a structure of an insulator 38 mounted on each of a plurality of teeth portions 35 aligned in a motor circumferential direction Dc, including: an outer circumferential piece 41 that is provided on one end side in a teeth portion axis direction Dt1 along a motor radial direction Dr in a teeth portion 35; an inner circumferential piece 42 that is provided on another end side in the teeth portion axis direction Dt1 in the teeth portion 35 and faces the outer circumferential piece 41 in the teeth portion axis direction Dt1; and a winding portion 43 which covers an outer circumference of the teeth portion 35 when seen from the teeth portion axis direction Dt1, connects the outer circumferential piece 41 to the inner circumferential piece 42, and around which a winding wire 32 is wound, wherein a space surrounded by a first facing surface 41a of the outer circumferential piece 41 that faces an inner circumferential piece 42 side, a second facing surface 42a of the inner circumferential piece 42 that faces an outer circumferential piece 41 side, and an outer surface 43a of the winding portion 43 is a storage portion 45 of the winding wire 32, a protrusion portion 46, 47 that is arranged on one side (both outer sides in the embodiment) in the motor circumferential direction Dc and protrudes to one side in a motor axis direction Da further than the winding portion 43 and an inner circumferential side recess portion 49 which is arranged (on the inner side in the motor circumferential direction Dc) to avoid the protrusion portion 46, 47 in the motor circumferential direction Dc, which is recessed in the motor axis direction Da relative to the protrusion portion 46, 47, and through which the winding wire 32 is capable of being inserted across an outer side and an inner side in the motor radial direction Dr of the inner circumferential piece 42 are provided on a first side in the motor axis direction Da of the inner circumferential piece 42, a protrusion portion inclination surface 48 that is inclined so as to be located at an outer position in the motor radial direction Dr from one side toward another side in the motor circumferential direction Dc when seen from the motor axis direction Da and causes an extension section to another side in the motor circumferential direction Dc to intersect the inner circumferential side recess portion 49 is provided on an inner end section in the motor radial direction Dr of the protrusion portion 46, 47, and an inclination groove portion 52 that is inclined along the extension section of the protrusion portion inclination surface 48 when seen from the motor axis direction Da and enables insertion of the winding wire 32 is provided on a first side in the motor axis direction Da of the insulator 38.

According to this configuration, the protrusion portion 46, 47 as a tangle portion or the like of the winding wire is formed on a first side in the motor axis direction Da in the inner circumferential piece 42 of the insulator 38, the inner circumferential side recess portion 49 is formed at a position that avoids the protrusion portion 46, 47, the protrusion portion inclination surface 48 that is inclined to the outer side (winding portion 43 side) in the motor radial direction Dr is formed on the outer end section in the motor radial direction Dr of the protrusion portion 46, 47, and the inner circumferential side recess portion 49 through which the winding wire 32 passes and the inclination groove portion 52 in which the winding wire 32 is inserted are formed in the extension direction of the protrusion portion inclination surface 48. When introducing the winding wire 32 toward the winding portion 43 from an access region on a further inner side in the motor radial direction Dr than the inner circumferential piece 42, by introducing the winding wire 32 along the protrusion portion inclination surface 48 to the winding portion 43 side, the winding wire 32 linearly extends, passes through the inner circumferential side recess portion 49, and is inserted into the inclination groove portion 52. In this way, by storing a winding starting portion 32a of the winding wire 32 in the inclination groove portion 52 and guiding the winding wire 32 toward the winding portion 43 from the inner circumferential piece 42 side (the inner side in the motor radial direction Dr), it is possible to improve the workability of the winding wire 32. Further, by providing an inclination toward the outer side from the inner side in the motor radial direction Dr, it is possible to improve the adhesiveness to the winding portion 43 of the winding wire 32, prevent the winding wire 32 from flying out into a slot 36, ensure the alignment property of an upper layer and a subsequent layer, and reduce the physical size of a coil end.

In the insulator structure described above, in a cross section that intersects the motor radial direction Dr, a chamfering shape 43d is formed on the winding portion 43 at a corner section between an axis direction end surface 43b on a first side in the motor axis direction Da and a circumferential direction end surface 43c on another side in the motor circumferential direction Dc, and in the cross section that intersects the motor radial direction Dr, a second inclination groove portion 54 that is inclined along the chamfering shape 43d, continues in an extension direction to another side in the motor circumferential direction Dc of the inclination groove portion 52 when seen from the motor axis direction Da, and enables insertion of the winding wire 32 is provided on a first side in the motor axis direction Da of the insulator 38.

According to this configuration, by enabling insertion of the winding wire 32 into the second inclination groove portion 54 that communicates with the extension direction of the inclination groove portion 52 and inclining the second inclination groove portion 54 along the chamfering shape 43d of the winding portion 43 in a cross-sectional view, when introducing the winding wire 32 toward the winding portion 43 from the access region on the further inner side in the motor radial direction Dr than the inner circumferential piece 42, the winding wire 32 smoothly merges to a corner section in the cross-sectional view of the winding portion 43. Thereby, by preventing bending or curving at the winding starting portion 32a of the winding wire 32 and improving the adhesiveness between the winding wire 32 and the insulator 38, it is possible to prevent the winding wire 32 from flying out into the slot 36, ensure the alignment property of the upper layer and the subsequent layer, and reduce the physical size of the coil end.

In the insulator structure described above, a pair of protrusion portions 46, 47, a pair of inclination groove portions 52, and a pair of second inclination groove portions 54 are provided to be symmetric using a center axis line Ct of the teeth portion 35 as a symmetry axis when seen from the motor axis direction Da.

According to this configuration, by providing the pair of protrusion portions 46, 47, the pair of inclination groove portions 52, and the pair of second inclination groove portions 54 so as to be symmetric in the motor circumferential direction Dc, regardless of a direction of the winding starting portion 32a of the winding wire 32 with respect to the winding portion 43 being a CCW (counterclockwise) or a CW (clockwise), it is possible to prevent the winding wire 32 from flying out into the slot 36, ensure the alignment property of the upper layer and the subsequent layer, and reduce the physical size of the coil end.

The present invention is not limited to the embodiment described above. For example, the insulator structure of the embodiment may be applied to a dynamoelectric machine other than a vehicle drive motor. For example, the dynamoelectric machine shown in the embodiment as an example is an inner rotor type motor; however, the present invention is not limited to this configuration. For example, the dynamoelectric machine may be an outer rotor type machine in which the rotor is arranged on an outer circumferential side relative to the stator. Further, the dynamoelectric machine is not limited to the motor and may be a generator. The present invention may be applied not to the insulator of the rotor but to an insulator of the stator.

The configuration in the embodiment described above is an example of the present invention, and various changes can be made without departing from the scope of the present invention such as substitutions of the components of the embodiment with well-known components.

What is claimed is:

1. An insulator structure which is a structure of an insulator mounted on each of a plurality of teeth portions aligned in a motor circumferential direction, comprising:
an outer circumferential piece that is provided on one end side in a teeth portion axis direction along a motor radial direction in a teeth portion among the plurality of teeth portions;
an inner circumferential piece that is provided on another end side in the teeth portion axis direction in the teeth portion and faces the outer circumferential piece in the teeth portion axis direction; and
a winding portion which covers an outer circumference of the teeth portion when seen from the teeth portion axis direction, connects the outer circumferential piece to the inner circumferential piece, and around which a winding wire is wound,
wherein a space surrounded by a first facing surface of the outer circumferential piece that faces an inner circumferential piece side, a second facing surface of the inner circumferential piece that faces an outer circumferential piece side, and an outer surface of the winding portion is a storage portion of the winding wire,
a protrusion portion that is arranged on one side in the motor circumferential direction and protrudes to one side in a motor axis direction further than the winding portion and an inner circumferential side recess portion which is arranged to avoid the protrusion portion in the motor circumferential direction, which is recessed in the motor axis direction relative to the protrusion portion, and through which the winding wire is capable of being inserted across an outer side and an inner side in the motor radial direction of the inner circumferential piece are provided on a first side in the motor axis direction of the inner circumferential piece,
a protrusion portion inclination surface that is inclined so as to be located at an outer position in the motor radial direction from one side toward another side in the motor circumferential direction when seen from the motor axis direction and causes an extension section to another side in the motor circumferential direction to intersect the inner circumferential side recess portion is provided on an inner end section in the motor radial direction of the protrusion portion, and
an inclination groove portion that is inclined along the extension section of the protrusion portion inclination surface when seen from the motor axis direction and enables insertion of the winding wire is provided on a first side in the motor axis direction of the insulator.

2. The insulator structure according to claim 1,
wherein in a cross section that intersects the motor radial direction, a chamfering shape is formed on the winding portion at a corner section between an axis direction end surface on a first side in the motor axis direction and a circumferential direction end surface on another side in the motor circumferential direction, and
in the cross section that intersects the motor radial direction, a second inclination groove portion that is inclined along the chamfering shape, continues in an extension direction to another side in the motor circumferential direction of the inclination groove portion when seen from the motor axis direction, and enables insertion of the winding wire is provided on a first side in the motor axis direction of the insulator.

3. The insulator structure according to claim 2,
wherein a pair of protrusion portions, a pair of inclination groove portions, and a pair of second inclination groove portions are provided to be symmetric using a center axis line of the teeth portion as a symmetry axis when seen from the motor axis direction.
